(19) United States
(12) Patent Application Publication
(10) Pub. No.: US 2012/0081357 A1
(43) Pub. Date: Apr. 5, 2012

(54) SYSTEM AND METHOD FOR INTERACTIVE PAINTING OF 2D IMAGES FOR ITERATIVE 3D MODELING

(76) Inventors: Martin Habbecke, Aachen (DE); Leif Kobbelt, Aachen (DE)

(21) Appl. No.: 12/896,371

(22) Filed: Oct. 1, 2010

(51) Int. Cl. G06T 15/00

(52) U.S. Cl. 345/419

(57) ABSTRACT

A system, method and user interface for interactive mesh painting of 2D images for iterative high quality 3D modeling is disclosed herein. The system takes a set of calibrated 2D images as input and provides an intuitive user interface based on simple interactive 2D painting operations. The output is a textured, high quality 3D model that on average is obtained after just a few minutes of interaction. This can be achieved by utilizing only a minimum number of different modes (panning, zooming, painting) when interacting with the 2D images. In an embodiment, a component of the system is a GPU-based multi-view stereo reconstruction scheme, which is implemented by an incremental reconstruction algorithm, that runs in the background during user interaction with a 2D image so that the user does not notice any significant response delay in generation of the corresponding modeled 3D surface.

### FIELD OF THE INVENTION

The present invention relates generally to computer modeling and in particular to systems and methods for three-dimensional (3D) modeling from two-dimensional (2D) images.

### BACKGROUND OF THE INVENTION

The reconstruction of realistic 3D models from 2D photos and videos is a common problem and over the last decades many different techniques have been proposed. However, most of the classical approaches utilize automatic algorithms that are controlled by a number of, more or less, intuitive parameters such as thresholds and weight coefficients. Due to numerous sources for errors such as image noise, lack of foreground segmentation, miscalibration, and ambiguous visibility, the applicable algorithms generally cannot use one single default set of parameters for all inputs. Instead the user needs to adjust them accordingly. As a consequence, the application of such algorithms requires a certain level of technical expertise from the user and normally the parameters have to be adjusted in a trial and error process that is relatively time consuming.

Recently, interactive reconstruction techniques have come into focus. Using these techniques, the user sketches rough hints through a graphical user interface, which are used by the system to adjust parameters and as boundary constraints for the reconstruction. The idea to interactively generate 3D models from digital images has been explored in several earlier publications and software systems. The Facade system by Debevec et al. [Debevec P. E., Taylor C. J., Malik J.: Modeling and rendering architecture from photographs. In Proc. ACM SIGGRAPH (1996)] generates 3D models by manually building geometry proxies and linking related edges in several images. Similarly, the commercial software package Photo-Modeler by Eos Systems and the PhotoMatch component of Google's SketchUp allow for the manual creation of 3D models based on images. However, these systems shift most of the work of building the geometry proxies to the user and therefore may be time consuming to use.

Other interactive image-based 3D modeling systems have been proposed that exploit precomputed structure from motion information. For example, VideoTrace by van den Hengel et al. [V. D. Hengel A., Dick A. R., Thormählen T., Ward B., Torr P. H. S.: Videotrace: rapid interactive scene modelling from video. ACM Trans. Graph. 26, 3 (2007)] and the architectural modeling system proposed by Sinha et al. [Sinha S. N., Steedly D., Szeliski R., Agrawala M., Pollefeys M.: Interactive 3d architectural modeling from unordered photo collections. ACM Trans. Graph. 27, 5 (2008)] allow for interactive generation of 3D models by first sketching polygons in a user-selected image and then manually adjusting the positions of projected vertices and edges. Both systems use scene points or automatically detected vanishing points and lines to guide the user while editing. However, these systems suffer from the inability to reproduce fine surface structure and geometric detail since the reconstructed model consists of a coarse collection of planar polygons only.

Thormählen and Seidel [Thormählen T., Seidel H. P.: 3d-modeling by orthoimage generation from image sequences. ACM Trans. Graph. 27, 3 (2008)] have taken a different approach by generating orthographic images from a calibrated input sequence. Users are then supposed to load these images into their modeling package of choice and do the actual modeling manually. While this works well for mechanical and especially symmetric objects, it is difficult to create models where the symmetry is less apparent or for entire scenes. The level of surface detail is also completely up to the user's manual effort.

The single view modeling approaches by Zhang et al. [Zhang L., Dugas-Phocion G., Samson J. S., Seitz S. M.: Single view modeling of free-form scenes. Journal of Visualization and Computer Animation 13, 4 (2002), 225-235] and Prasad et al. [Prasad M., Zisserman A., Fittzgibbon A.: Single view reconstruction of curved surfaces. In Proc. of CVPR (2006)] also follow the idea of user-guided reconstruction. However, since these methods are limited to single input images, the user interactions are more complex.

### SUMMARY OF THE INVENTION

The present invention relates to a system and method for interactive image-based modeling that enables a user to quickly generate detailed 3D models with texture from a set of calibrated 2D input images. As will be described in more detail below, in one aspect of the present invention, an intuitive user interface is entirely based on simple interactive 2D painting operations, and does not require any technical expertise by the user or difficult pre-processing of the input images. In an embodiment, a component of the system is a GPU-based multi-view stereo reconstruction scheme, which is implemented by an incremental reconstruction algorithm, that runs in the background during user interaction with a 2D image so that the user does not notice any significant response delay in generation of the corresponding modeled 3D surface.

More generally, the system takes a set of calibrated 2D images as input and provides an intuitive graphical user interface to allow the user to easily interact with the 2D image. The output is a textured, high quality 3D model that on average is obtained after just a few minutes of interaction. As detailed further below, this can be achieved by utilizing only a minimum number of different modes (panning, zooming, painting) when interacting with the 2D images. In addition, a 3D interaction may be used which allows the rotation of a partially or fully reconstructed 3D model corresponding to the 2D images.

Advantageously, the system does not require precise user input or image correlation, such as picking feature points or lines. Moreover, it is not necessary to segment foreground from background in the image. Rather, when the user paints over a region in a 2D image to be reconstructed in the corresponding 3D model, the user can safely stay away from the object silhouette (i.e. the boundary between the object and the background) and choose another 2D image with a different angle of view where this surface part is not near the object silhouette for its reconstruction.

With existing algorithms and systems, it can take several minutes or even hours of computation time to reconstruct an object of moderate complexity. This is what makes the parameter tuning for automatic reconstruction algorithms so tedious: the response times when changing a parameter are too long to give the impression of direct control. In contrast, the present invention implements an incremental reconstruction scheme that runs in parallel to the user activity. By doing so, computation times are effectively “hidden” within the interaction dialog. As a consequence, the user does not sense any significant processing delay, resulting in a more interactive modeling experience.

A central motivation and justification for the interactive reconstruction method of the present invention is that putting the user into the modeling loop enables a better streamlined workflow leading to shorter overall process times from raw input data to the final result. Even if user time is usually significantly more expensive than CPU time, the overall process time must be considered in applications where the result is needed quickly.

So-called automatic reconstruction algorithms require careful tuning of a set of parameters before the reconstruction runs automatically. If the result is not satisfactory, the parameters have to be adjusted and the reconstruction re-run. Hence, the overall process could also be considered “interactive” because the system computes in between two manual parameter changes. However, the interactive 2D image viewer user interface that is proposed in the present invention is much more intuitive to handle than the parameters of existing multi-view stereo algorithms.

Practical experience shows that it is not easy to fix a broken, wrongly reconstructed model after a possibly fully automatic reconstruction process. The artifacts one encounters are not just small holes that can easily be filled, but rather surface parts that deviate from the true surface due to, for instance, local matching errors. In a post-process, with a standard surface editing tool, the input images are not available anymore. Hence, it is not possible to determine the correct position of the surface. In contrast, the system in accordance with the present invention allows for the easy and immediate validation and correction of the surface with the help of the 2D input images and as an integral part of the actual reconstruction process. Moreover, by utilizing a simple 2D painting metaphor, the user interface according to the present invention requires less user skill than a 3D polygon mesh modeling tool.

Earlier work has been completed in the field of multi-view stereo reconstruction and depth-map recovery from images based on explicit surface representations by triangle meshes: Zhang and Seitz [Zhang L., Seitz S. M.: Image-based multiresolution shape recovery by surface deformation. In Proc. SPIE (2001), pp. 51-61] as well as Isidoro and Sclaroff [Isidoro J., Sclaroff S.: Stochastic refinement of the visual hull to satisfy photometric and silhouette consistency constraints. In Proc. ICCV (2003), pp. 1335-1342] deform a mesh by moving single vertices according to an energy functional; Esteban and Schmitt [Esteban C. H., Schmitt F.: Silhouette and stereo fusion for 3d object modeling. CVIU 96, 3 (2004), 367-392] add surface smoothness and silhouette constraints. More recently, Delaunoy et al. [Delaunoy A., Prados E., Gargallo P., Pons J. P., Sturm P.: Minimizing the multi-view stereo reprojection error for triangular surface meshes. In Proc. BMVC (2008)] have presented a mesh based multi-view stereo formulation that rigorously integrates visibility information into the gradients of the error terms. However, none of the above methods has been designed for interactivity; rather, they function as black boxes with prohibitively long computation times for an interactive system. In addition, a good initialization of the complete surface or even exact image silhouettes are required, which can be difficult to acquire in uncontrolled setups. In contrast, the present invention does not rely on any preprocessing or initial surface, and is hence very flexible with respect to the input data.

Recent region growing reconstruction methods by Furukawa and Ponce [Furukawa Y., Ponce J.: Accurate, dense, and robust multi-view stereopsis. In Proc. CVPR (2007)], Goesele et al. [Goesele M., Snavely N., Curless B., Hoppe H., Seitz S. M.: Multi-view stereo for community photo collections. In Proc. ICCV (2007)], and the present inventors Habbecke and Kobbelt [Habbecke M., Kobbelt L.: A surface-growing approach to multi-view stereo reconstruction. In CVPR (2007)] introduce the idea of extending a known part of the surface into unknown regions. The main benefit of this procedure is that known surface parts serve well as initialization for the recovery of unknown surface regions. This concept is integrated into the present interactive framework by enabling the user to actively extend the reconstructed surface through simple 2D painting interactions. While these earlier approaches yield results of high quality, surface growing approaches usually have two disadvantages. First, they generate seeds on a regular grid of image positions since there is no way to automatically determine which parts of a scene are supposed to be reconstructed. This results in a large number of seeds that have to be discarded and requires long computation times. In addition, they fit surface elements individually rather than integrating a global regularization term. In contrast, the patch-based approach of the present invention overcomes both weaknesses by only reconstructing what the user desires and by incorporating a geometrically meaningful surface smoothness term. It hence gains robustness—especially in the case of regions with little or no texture.

Zach [Zach C.: Fast and high quality fusion of depth maps. In Proc. of 3DPVT (2008)] has presented a depth map fusion algorithm that is related to the present method since it generates reconstruction results of comparable quality and speed due to a GPU implementation. However, its main focus does not lie on the actual reconstruction from images, the results hence largely depend on the quality of the input depth maps. Furthermore, since it is based on a volumetric approach implemented with a flat memory layout on the GPU, the achievable resolution is rather limited.

Recent advances in interactive image editing and processing tools have shown that even complex problems can be made accessible by simple 2D user interfaces. In addition to the above mentioned modeling tools, particular examples are an interactive image completion system [Pavic D., Schönefeld V., Kobbelt L.: Interactive image completion with perspective correction. The Visual Computer 22, 9-11 (2006), 671-681], unwrap mosaics for video editing [Rav-Acha A., Kohli P., Rother C., Fitzgibbon A. W.: Unwrap mosaics: a new representation for video editing. ACM Trans. Graph. 27, 3 (2008)] and an interactive image matting approach [Wang J., Agrawala M., Cohen M. F.: Soft scissors: an interactive tool for realtime high quality matting. ACM Trans. Graph. 26, 3 (2007)], to name a few. While not related technically, the system in accordance with the present invention approaches a difficult problem with a very simple interface.

In an embodiment, the user interface of the system in accordance with the present invention consists of a 2D image viewer and a 3D object viewer. Both viewers are synchronized such that panning or zooming a 2D image triggers the corresponding transformation in the 3D viewer. When rotating the object displayed in the 3D viewer, the 2D viewer switches to the input image that best matches the current viewing direction and performs a 2D rotation and scaling of the corresponding 2D image according to the orientation of the camera.

For each user-painted region in a 2D image, the system generates a 3D surface patch by reconstructing a depth map. Since painting is merely activating pixels in a 2D image, the user can easily switch back to a previous 2D image and extend or trim the corresponding patch. Extending an existing image region yields a seamlessly enlarged surface patch. Painting in a new, unpainted 2D image triggers the generation of a new, individual patch.

In an embodiment, the system overlays the input images with 2D projections of the already recovered surface which enables the user to easily spot uncovered regions. During an interactive modeling session, the user hence incrementally paints the object or scene to be reconstructed with simple brush strokes in a series of 2D images showing an object from different angles, thereby guiding the surface reconstruction algorithm in generating the 3D model.

Because interactive brush strokes are used in a series of 2D images, the maximum number of depth values that have to be computed simultaneously is limited by the maximum stroke size. For such small problems, the present invention uses a hierarchical reconstruction algorithm which converges in a fraction of a second to generate the corresponding 3D surface patch, which is about the time the user needs to draw the next stroke. Hence, the user does not notice the delay caused by the computation, as he is busy with the next stroke. This gives the impression of a fluent workflow similar to traditional modeling or photo editing systems.

In this respect, before explaining at least one embodiment of the invention in detail, it is to be understood that the invention is not limited in its applications to the details of construction and to the arrangements of the components set forth in the following description or illustrated in the drawings. The invention is capable of other embodiment and of being practiced and carried out in various ways. Also, it is to be understood that the phraseology and terminology employed herein are for the purpose of description and should not be regarded as limiting.

### DESCRIPTION OF THE DRAWINGS

FIG. 1(a) depicts an interactive user interface for inputting a user-painted image region over an image in a 2D image viewer, wherein a 2D image of an object is displayed adjacent a corresponding modeled surface patch in a 3D image viewer.

FIG. 1(b) depicts the interactive user interface of FIG. 1(a) in which a different angle view of the 2D image of the object is displayed adjacent a corresponding rotated modeled surface patch of the mesh in the 3D image viewer.

FIG. 1(c) depicts the interactive user interface of FIG. 1(b) in which the position of the surface patch can be adjusted by dragging its projection in the 2D viewer over the object.

FIG. 1(d) depicts the interactive user interface of FIG. 1(c) in which the surface patch in the 3D image is generated utilizing an incremental surface depth reconstruction algorithm based on mesh deformation.

FIG. 2(a) depicts a front view of a reconstruction of an outdoor statue with difficult topology and changing lighting conditions.

FIG. 2(b) depicts a rear view of a reconstruction of the outdoor statue of FIG. 2(a).

FIG. 2(c) depicts a front view of a reconstruction of a monkey sculpture with detailed surface texture.

FIG. 2(d) depicts a rear view of the reconstruction of the monkey sculpture of FIG. 2(c).

FIG. 2(e) depicts a front view of a Chinese Warrior statue with detailed surface texture.

FIG. 2(f) depicts a rear view of the reconstruction of the Chinese Warrior statue of FIG. 2(e).

FIG. 3(a) depicts a 2D image of an indoor scene.

FIG. 3(b) depicts a partial reconstruction of a 3D model generated from a set of 2D images of the indoor scene of FIG. 3(a) shown adjacent to a further processed textured version of the generated 3D model.

FIG. 3(c) depicts the partial reconstruction of the 3D model of FIG. 3(b) from another view, and shown adjacent to a further processed textured version of the generated 3D model.

FIG. 4(a) depicts a reconstruction of the Middlebury Dino object adjacent a further processed textured version.

FIG. 4(b) depicts a reconstruction of the Dino object of FIG. 4(a) shown at a different level of processing.

FIG. 4(c) depicts a partial reconstruction of a temple sculpture adjacent a further processed textured version of the temple.

FIG. 4(d) depicts a partial reconstruction of the temple sculpture of FIG. 4(c), shown at a different level of processing.

FIGS. 5(a), 5(b) and 5(c) depict illustrative examples of automatic reconstruction performed in accordance with a prior art method of 3D modeling.

FIG. 6 is a generic computer device that may provide a suitable operating environment for the invention.

### DETAILED DESCRIPTION OF THE PREFERRED EMBODIMENTS

Various embodiments of the system, method and user interface of the present invention for interactive mesh painting of 2D images for iterative high quality 3D modeling are now described.

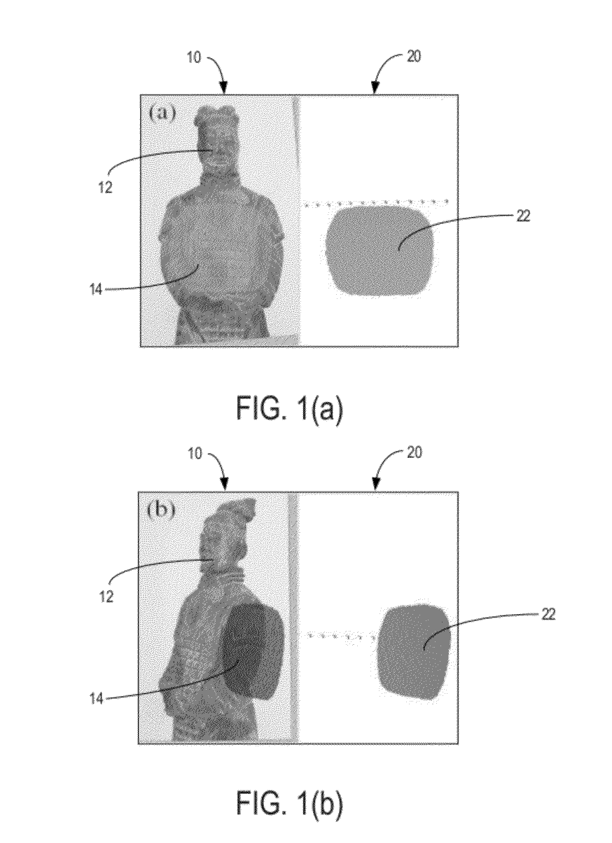

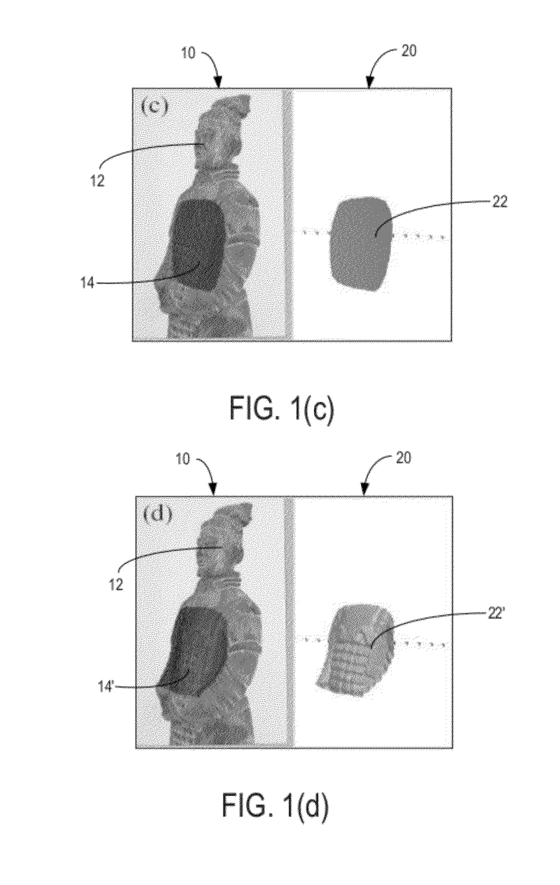

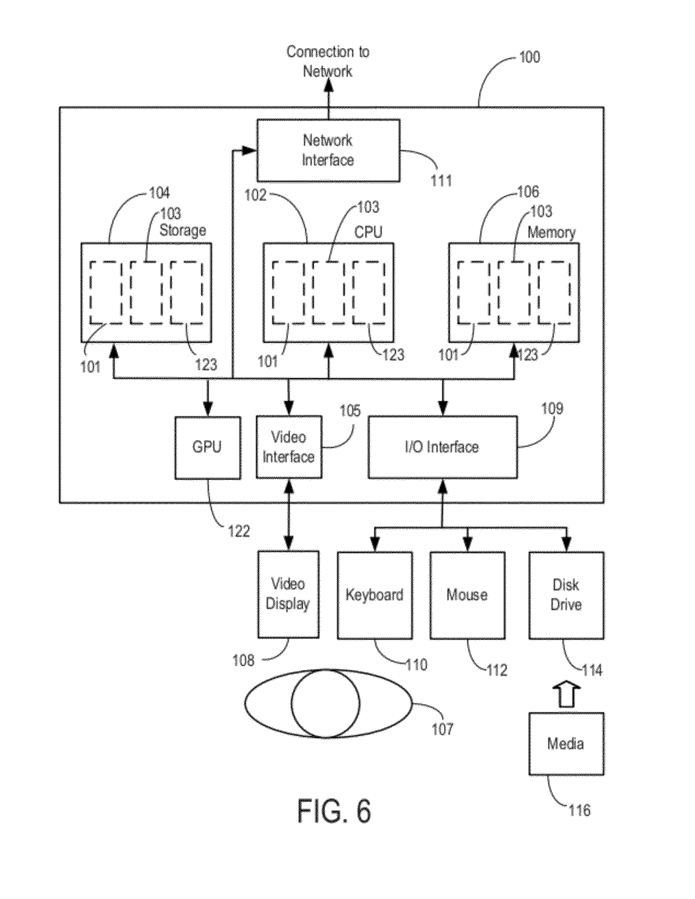

In one embodiment, a system in accordance with the present invention consists of a user interface comprising a 2D viewer and a 3D viewer. As shown in FIG. 1(a), both 2D viewer 10 and 3D viewer 20 may be displayed adjacent each other on a display 108 (FIG. 6, below). However, other arrangements enabling viewing of both the 2D image and corresponding 3D image are possible.

Both viewers 10, 20 are synchronized such that panning or zooming a 2D image in the 2D viewer 10 triggers the corresponding transformation in the 3D viewer 20. In one embodiment, the scale of object 12 in the 2D viewer 10 is substantially the same as the scale of the modeled object displayed in 3D viewer 20. However, it will be understood that 2D viewer 10 and 3D viewer 20 may display their respective object and modeled object at different scales.

Now referring to FIG. 1(b), when rotating the point of view or viewing direction of the object displayed in 3D viewer 20, 2D viewer 10 switches to the input image that best matches the current viewing direction and performs a 2D rotation and scaling according to the orientation of the camera. Hence 3D viewer 20 can be considered an image selection tool similar to the photo viewer of Snavely et al. [Snavely N., Garg R., Seitz S. M., Szeliski R.: Finding paths through the world's photos. ACM Trans. Graph. 27, 3 (2008)]. However, unlike the Snavely system, the present invention does not apply perspective distortions to the input images to keep them as true 2D entities. This is done to limit the user interactions to 2D painting on a fronto-parallel plane and thereby keep the user interface as simple as possible.

Still referring to FIG. 1(b), when a new surface patch 22 in 3D viewer 20 is created based on an interactively selected image region 12 in 2D viewer 10, the initial depth values of surface patch 20 are estimated from the depth information of neighboring patches or by intersecting the viewing direction vectors of nearby images. In some cases, this initialization may fail and the user has to provide an additional hint (similar to VideoTrace by van den Hengel et al.) by switching to a different, nearby image and dragging the projection of surface patch 22 to a better initial position, as shown in FIG. 1(c).

In addition to the image selection by panning, zooming, and rotation, the present invention provides a simple stroke-based interface with the modes “paint” and “erase” (un-paint) in the 2D image viewer for the actual surface reconstruction. For each user-painted region in a 2D image, the system generates a 3D surface patch by reconstructing a depth map. Since painting is merely activating pixels in an image, the user can easily switch back to a previous image and extend or trim the corresponding patch. Extending an existing image region yields a seamlessly enlarged surface patch. Painting in a new, unpainted image triggers the generation of a new, individual patch.

As shown in FIG. 1(c), the system overlays the input images with 2D projections of the already recovered surface which enables the user to easily spot uncovered regions. During an interactive modeling session, the user incrementally paints the object or scene to be reconstructed with simple brush strokes in 2D to enlarge the painted area, thereby guiding the surface reconstruction algorithm.

The raw input images for 2D viewer 10 may be calibrated using a suitable calibration tool, such as Boujou (developed by 2d3 Ltd. of Oxford, U.K.) and are loaded into the system without any further preprocessing such as foreground segmentation. The reconstruction algorithm runs in parallel to the user interaction. Whenever the user paints a stroke on a 2D image, the system starts reconstructing the depth values of the corresponding pixels in the 3D model right away. It should be understood that the present invention is not limited to the application of any particular calibration tool or process.

As a consequence, the maximum number of depth values that have to be computed simultaneously may be limited by the maximum stroke size, i.e. the size of the brush used, which may be defined for example as the number of pixels across the diameter of a circular shaped brush controllable by a mouse 112 (FIG. 6, below) or other navigational device such as a trackball, tracking pad or joystick, for example. For such small problems, a hierarchical reconstruction algorithm as described further below converges in a fraction of a second, which is about the time the user needs to draw the next stroke. Hence, the user does not notice the delay caused by the computation, as he is busy with the next stroke. This gives the impression of a fluent workflow similar to traditional modeling or photo editing systems. As an illustrative example, FIG. 1(d) shows surface patch 22′ which has been processed using a reconstruction algorithm to generate a 3D surface having depth information.

The precision requirements in the painting mode are not very strict since no special features have to be picked in the 2D images. Moreover, no precise painting along the object silhouette is required since the surface region that is close to the silhouette in one image can be reconstructed by painting on another image where this region is sufficiently far away from the silhouette.

When the user is satisfied with the visual quality of the reconstructed collection of surface patches, they are turned into a mesh, for example a solid triangle mesh or a rectangular mesh. For this purpose, by way of example, the method of Kazhdan et al. [Kazhdan M., Bolitho M., Hoppe H.: Poisson surface reconstruction. In Proc. of SGP (2006), pp. 61-70] may be used. Finally, the system automatically generates a texture atlas for the reconstructed mesh using the painted image regions as described further below.

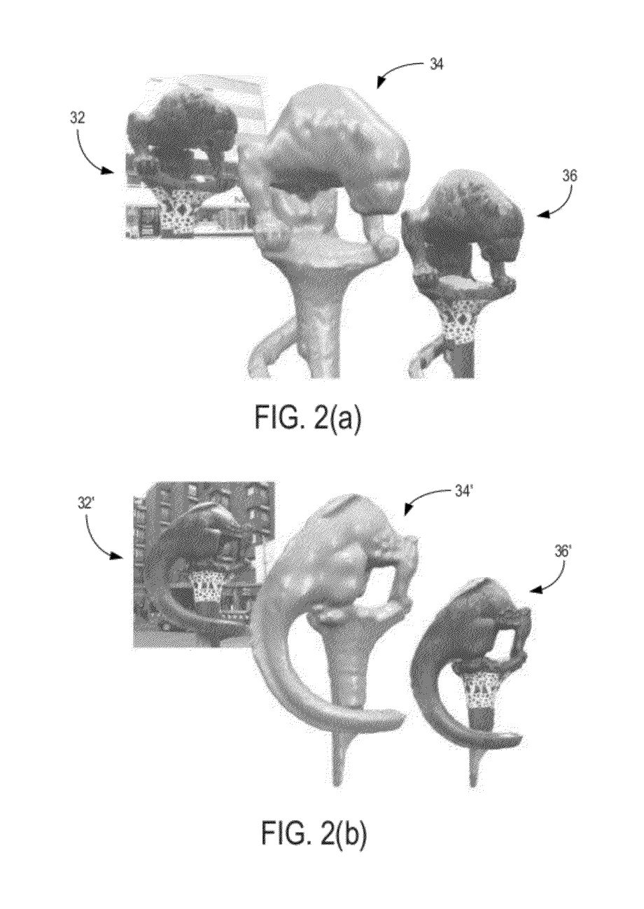

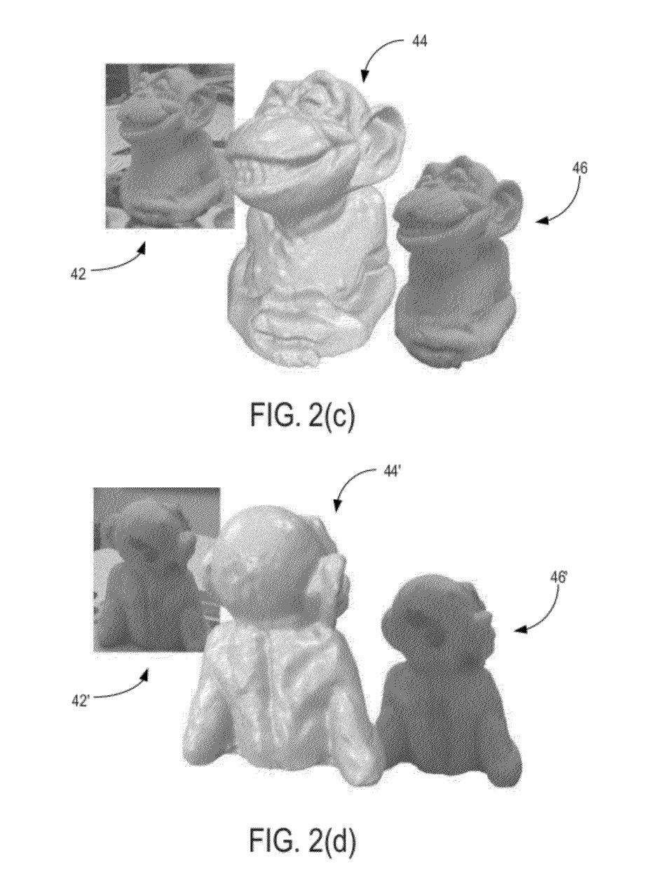

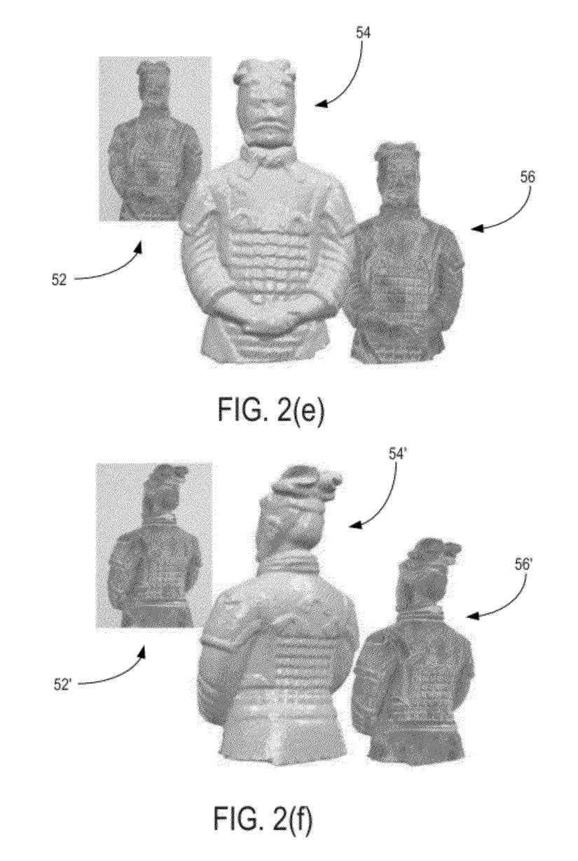

Illustrative results of the 3D modeling process are shown by way of example in FIGS. 2(a), 2(b), 2(c), 2(d), 2(e) and 2(f). For example, FIG. 2(a) shows original 2D digital image 32, corresponding 3D model 34, and a completed, textured 3D model 36 showing a high level of surface texture and detail. FIG. 2(b) shows another angle of view, of the object in digital image 32′, corresponding 3D model 34′, and a completed, textured 3D model 36′. Similarly, FIG. 2(c) shows an original 2D image 42 of another object, corresponding 3D model 44, and a completed, textured model 46. FIG. 2(d) shows another angle of view of the object in image 42′, 3D model 44′, and textured model 46′. Finally, FIG. 2(e) shows an original 2D image 52 of yet another object, the corresponding 3D model 54, and completed, textured model 56. FIG. 2(f) shows another point of view or viewing angle of the object in 2D image 53′, 3D model 54′ and textured model 56′.

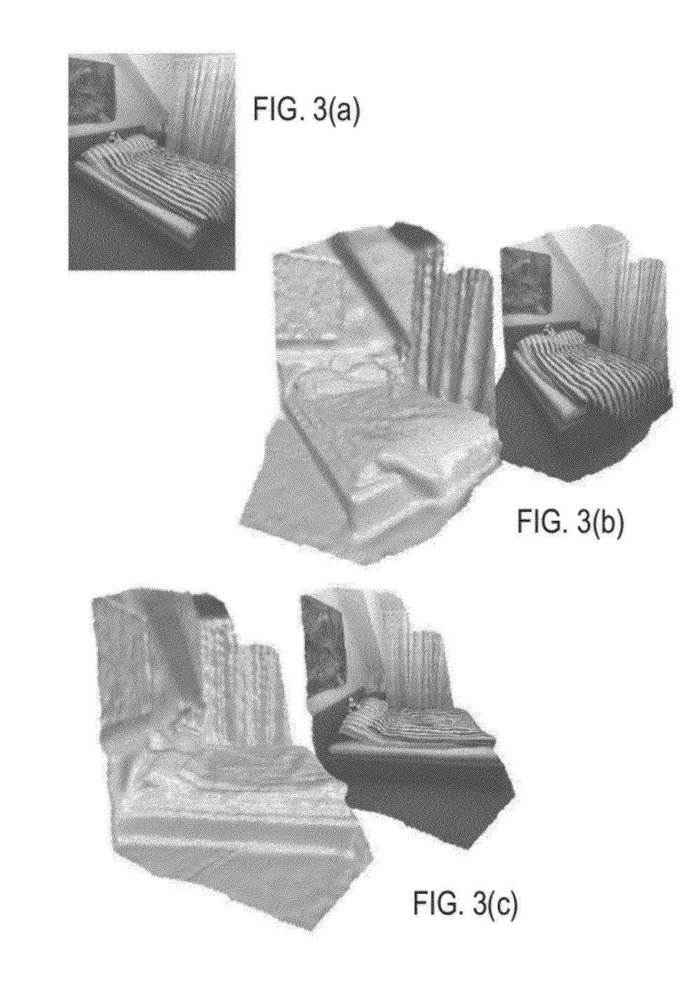

Similarly, FIG. 3(a) shows an illustrative example of a 2D image of an indoor scene. FIGS. 3(b) and 3(c) show different viewing angles of a reconstructed 3D model, in which the bedroom is fully textured. As shown, the system in accordance with the present invention can be applied to an indoor scene. Inside-out capturing scenarios as in this case (in contrast to outside-in capturing for objects) pose a severe problem to many existing reconstruction systems that rely on, e.g., the visual hull for surface initialization. However, the system in accordance with the present invention does not require a surface initialization or image pre-processing of any form and hence is flexible enough to cope with inside-out captured image sequences.

In an embodiment, surface patches are represented as 2D triangle meshes with per-vertex depth values attached and embedded in a reference image. Since the 2D images are calibrated, each such 2D mesh induces a 3D surface. For an efficient implementation of the depth reconstruction algorithm as described below, the system stores a hierarchy of triangle meshes with different resolutions for each input image. For a given resolution a regular mesh of equilateral triangles may be overlayed over the entire image. When a user selects a certain region of the image, all mesh vertices that lie within the painted region and all triangles that contain at least one active vertex are activated. The reconstruction algorithm is then applied to the active parts of the mesh only.

In order to propagate the depth information from coarse to fine levels in the mesh hierarchy for each vertex in the fine level the system stores the barycentric coordinates with respect to the coarse-level triangle into which it falls. This provides the necessary data for a prolongation operator based on piecewise linear interpolation. By default, the system uses three hierarchy levels with edge lengths of 5, 10, and 15 pixels. However, it will be appreciated that a different number of hierarchical levels and other edge lengths may be used.

The reconstruction algorithm takes as input a reference image I₀, a set of comparison images I₁ . . . Iₘ, and a 2D triangle mesh M embedded in h. The goal is to recover a depth value d for each vertex in M such that the resulting 3D triangle mesh M′ approximates the part of the scene visible in the region of I₀ covered by M. The two-view matching method described in Sugimoto et al. [Sugimoto S., Okutomi M.: A direct and efficient method for piecewise-planar surface reconstruction from stereo images. In Proc. CVPR (2007)] is extended to multiple views and add visibility terms as well as a regularization term. The latter term improves convergence and smoothes the resulting surface to compensate for inevitable image noise.

For each image Iⱼ, a 3×4 projection matrix (Pⱼ|−Pⱼcⱼ) is given where cⱼ is the projection center. The object space is pre-transformed such that (P₀|−P₀c₀)=(I|0)). By this transform, the relation between a point x in object space (i.e., a vertex of M₀), its projection p into the reference image (i.e., the associated vertex in M) and the corresponding depth value d simplifies to x=dp where p=(u; v;1) is given in extended coordinate notation.

For an object space triangle S the photo-consistency is measured by comparing the pixel colors in the projection of this triangle into reference image I₀ with the projections into comparison images Iⱼ. Since the mesh M₀ is parametrized by a depth field over I₀ there is a one-to-one correspondence between triangles in M₀ and M. Hence, starting with a triangle (p1,p2,p3)εM, the triangle can be un-projected to S=(d₁p₁;d₂p₂;d₃p₃) M′ and then mapped to some comparison image Iⱼ. The complete map from I₀ to Iⱼ via S can be written as

Hⱼ(S)=Pⱼ−Pⱼcⱼn(S)^{T}

where n(S) is the normal vector of S, scaled such that the equation of the embedding plane becomes n(S)^{T}x=1.

Let xᵢ=dᵢ(uᵢ,vᵢ,1) be the corners of S, then the normal vector can be derived from the plane equation by

$$n ( S ) = {( \begin{matrix}{u}_{1} & {v}_{1} & 1 \\ {u}_{2} & {v}_{2} & 1 \\ {u}_{3} & {v}_{3} & 1\end{matrix} )}^{- 1} ( \begin{matrix}1 / {d}_{1} \\ 1 / {d}_{2} \\ 1 / {d}_{3}\end{matrix} ) .$$

The multi-view objective function of the present invention sums over all comparison images Iⱼ and all triangles TεM the pixel color differences between T and its re-projections, i.e.,

$${E}_{1} = {\sum }_{j = 1}^{m} {\sum }_{T ∈ M} {\sum }_{p ∈ T} {( {I}_{0} ( p ) - {I}_{j} ( {H}_{j} ( T ) p ) )}^{2} .$$

Sugimoto and Okutomi minimize E₁ by applying a Gauss-Newton optimization, i.e., by computing the Jacobian J of E₁ and by solving J^{T}JΔ=J^{T}e for parameter updates D. Here e denotes the vector of per-pixel intensity differences. In an embodiment of the invention, a full Levenberg-Marquardt optimization is employed by augmenting the linear system to (J^{T}J+λI)Δ=J^{T}e [see Nocedal J., Wright S.: Numerical Optimization, 2nd ed. Springer, 2006]. This implies an algorithm that iteratively updates initial depth estimates by solving a sparse linear system for the per-vertex depth values.

This approach is further extended by integrating a visibility term for each face of the mesh M. The binary weight z_{j,T} is determined by OpenGL rendering the 3D mesh M₀ and all other previously reconstructed surface patches into Iⱼ, and the continuous confidence weight c_{j,T} is computed by the cosine of the angle between the face normal and the viewing direction:

$${E}_{2} = {\sum }_{j = 1}^{m} {\sum }_{T ∈ M} {z}_{j , T} {c}_{j , T} {\sum }_{p ∈ T} {( {I}_{0} ( p ) - {I}_{j} ( {H}_{j} ( T ) p ) )}^{2} . \qquad ( 1 )$$

Finally, a surface regularization term Eₛₘₒₒₜₕ is added based on a discrete Laplace operator for triangle meshes

$${E}_{smooth} = {\sum }_{x ∈ {M}^{′}} {L ( x )}^{T} L ( x ) , L ( x ) := {\sum }_{{x}_{i} ∈ N ( x )} ( {x}_{i} - x )$$

Where N(x) denotes the set of 1-ring neighbors of x in M. Then, the complete objective function is

E₃=E₂+αEₛₘₒₒₜₕ.

The global weight a can be chosen as

α˜m·|∪T|/(|V|·e_{avg}²),

where m is the number of comparison images, |∪T| is the total number of pixels covered by projected triangles T in I₀, and |V| is the number of vertices in M. The unknown scale of the scene is compensated for by the average edge length e_{avg} of M₀ in object space. Since α also depends on the quality of the input images it is difficult to set it fully automatically. However, in experiments conducted by the inventors, by choosing the weight according to the above heuristic, the weight a only had to be slightly adjusted by a constant factor that was kept fixed for each individual image sequence in experiments conducted by the inventors.

In order to significantly accelerate the convergence of the iterative solver, a hierarchical cascading scheme can be run that first computes the best fit for a coarse mesh M₀, prolongates this solution to the next finer level M₁, and continues iterating. Since the sparse linear system solver takes most of the computation time, only the mesh resolution is reduced and not the image resolution. Experiments conduct by the inventors have shown that it has a positive effect on the overall performance to reduce the number of comparison images m on coarse levels and only use the complete set of images on the finest level.

Depth values can be initialized by propagating the depth information from neighboring, previously reconstructed patches. This information is obtained by rendering all front facing patches into the reference image I₀ and reading out the z-buffer. Initial depth values are then propagated to neighboring vertices in M which are not covered by the rendering of a previously reconstructed surface patch. In case none of the vertices of a new patch overlaps with an existing part of the surface, the system according to the present invention falls back to a simple depth estimation heuristic that intersects viewing rays of the current and a nearby camera.

To compensate for non-Lambertian lighting conditions, a simple intensity normalization is applied by subtracting the average per-triangle intensities μ_{j,T}. The inner term of E₂ in (1) is hence extended to

$${\sum }_{p ∈ T} {( ( {I}_{0} ( p ) - {μ}_{0 , T} ) - ( {I}_{j} ( {H}_{j} ( T ) p ) - {μ}_{j , T} ) )}^{2} .$$

In experiments conducted by the inventors, additional division by per-triangle intensity standard deviation has not shown to improve results.

In an embodiment, the complete evaluation of the data term (1) and the computation of its partial derivatives with respect to the vertex depth values may be implemented in CUDA (Compute Unified Device Architecture)—a parallel computing architecture developed by NVIDIA of Santa Clara, Calif. The main difficulty is the irregularity of the triangle mesh patches: Since patch boundaries can be arbitrary, it is not possible to find a regular layout for face and vertex data that enables coalesced memory accesses. The present system and method introduces a level of indirection by uploading a map from face indices to the three respective vertex indices of each face. All required face and vertex data can then simply be stored as linear arrays. Although this introduces incoherent memory accesses, experiments conducted by the inventors have found the CUDA implementation to outperform a similar CPU implementation by a large margin, as detailed further below.

By painting image regions in selected reference images, the user has explicitly specified which part of the surface is best seen in each of the input images. Similar to the approach of Sinha et al. (mentioned above), the system and method according to the present invention generates textures from the user-painted regions and hence ensures that no occluded or otherwise invalid image region is used for texturing. Since the Poisson fusion of the surface patches does not preserve the relation between surface regions and their respective reference image, the surface patches are projected onto the final mesh in normal direction. Small regions on the mesh without reference information are closed by a few breadth-first propagation steps. Connected components of triangles with the same reference image are found, and then projected to the respective images and generate a texture atlas and appropriate texture coordinates.

Experiments conducted by the inventors have been performed on an Intel Core 2 Duo E6750 system. CUDA was run on a GeForce 8800 GTX graphics card.

TABLE 1

| L | #ci | #f | #v | #s | CUDA | CPU | Solve |
|---|---|---|---|---|---|---|---|
| 1 | 10 | 1000 | 548 | 18 | 1.13 | 57.34 | 1.86 |
| 2 | 2 | 226 | 135 | 67 | 0.70 | 9.20 | 0.20 |
| 3 | 2 | 91 | 60 | 148 | 1.32 | 8.26 | 0.07 |
| 1 | 10 | 8000 | 4130 | 18 | 6.17 | 464.91 | 30.00 |
| 2 | 2 | 1934 | 1032 | 67 | 1.59 | 79.26 | 4.36 |
| 3 | 2 | 832 | 459 | 148 | 1.91 | 76.35 | 4.36 |
| 1 | 10 | 16000 | 8224 | 18 | 12.34 | 936.84 | 70.02 |
| 2 | 2 | 3903 | 2063 | 67 | 3.04 | 161.40 | 10.03 |
| 3 | 2 | 1679 | 913 | 148 | 3.43 | 154.39 | 3.39 |

Table 1, above, summarizes the times required by the computation of partial derivatives of (1) as well as the solution of the sparse Levenberg-Marquardt system: “CUDA” denotes the partial derivative computation on the GPU, “CPU” an equivalent implementation on the host processor, and the “Solve” column contains the time required by the CHOLMOD sparse linear system solver [Chen Y., Davis T. A., Hager W. W., Rajamanickam S.: Algorithm 8xx: CHOLMOD, supernodal sparse Cholesky factorization and update/downdate. Technical Report TR-2006-005, University of Florida, 2006]. L, #ci, #f, #v, and #s denote the resolution level, the number of comparison images, the number of faces and vertices of the surface patch, and the maximal number of per-face sample points in the reference image, respectively. The measured times show that the CUDA implementation is faster than the CPU implementation by a factor of up to 75, and that most of the time is spent solving the linear system.

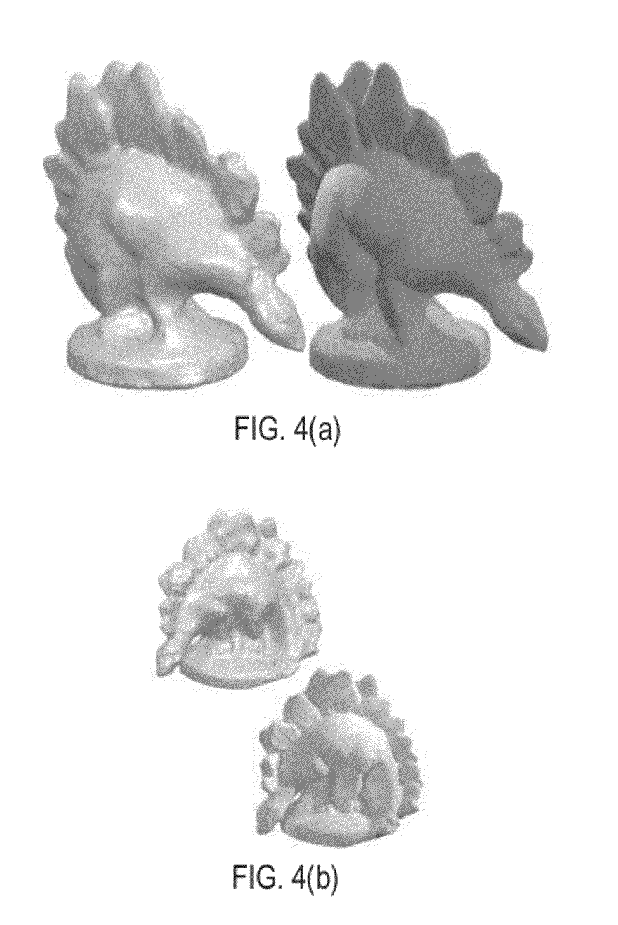

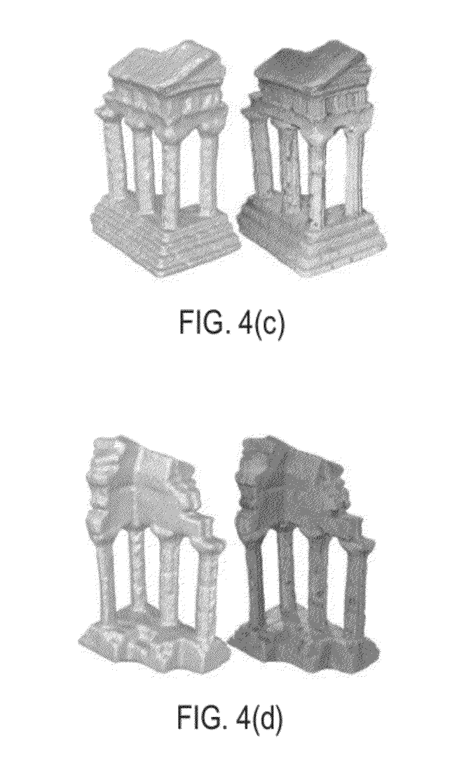

Now referring to FIGS. 4(a), 4(b), 4(c) and 4(d), for comparison purposes, shown are reconstruction results for the Middlebury Dino and Temple datasets [Seitz S. M., Curless B., Diebel J., Scharstein D., Szeliski R.: A comparison and evaluation of multiview stereo reconstruction algorithms. In Proc. CVPR (2006), pp. 519-528]. In both cases the full datasets with more than 300 images each were used. Measurement results obtained according to the present invention are: Temple: 90% within 0.6 mm, 98.4% within 1.25 mm. Dino: 90% within 0.52 mm, 99.1% within 1.25 mm. With these numbers, the system and method according to the present invention takes an average rank among all methods that have participated in the full dataset benchmark (please see Middlebury: Middlebury multi-view stereo evaluation results. http://vision.middlebury.edu/mview, 2009 for comparison).

However, the result for the Middlebury Dino data set demonstrates that the multi-view stereo (MVS) component of the present system in accordance with the invention is capable of robustly reconstructing almost completely textureless surfaces due to the integration of a large number of input images and the geometrically meaningful regularization term.

TABLE 2

| Model | Resolution | Images | Time |
|---|---|---|---|
| Bahkauv | 720 × 576 | 325 | 8 min |
| Monkey | 2496 × 1664 | 107 | 10 min |
| Room | 780 × 580 | 200 | 3 min |
| Warrior | 1024 × 768 | 127 | 3 min |
| Dino | 640 × 480 | 363 | 8 min |
| Temple | 640 × 480 | 312 | 16 min |

Regarding the computation times shown in Table 2, above, the present system outperforms almost all other methods, most of them by a large margin. At the time of experimenting only the depth map fusion method of Zach was faster than the interactive system in accordance with the present invention (again, please see Middelbury for details). The results in the Middlebury benchmark underline that the presently proposed system and method is able to solve one of the problems of current MVS systems: What matters most in many real applications is the time it takes to convert raw image data into a textured 3D model. Even if several hours of computing time (see most of the automatic methods in the Middlebury benchmark) might be less expensive than a few minutes of human interaction time, it does not help if a result is required as quickly as possible.

When capturing objects to model using a digital video camera, the inventors have found that following certain rules of thumb results in a better model output. Many cell phone cameras use high compression which produces undesirable artifacts and do not have a sufficiently high dynamic range, resulting in video that is often overexposed. Therefore, until the quality of cell phone cameras is improved, the inventors recommend that a quality digital camcorder or camera capable of recording video at high resolution be used which can capture sufficient details and texture in an object. Furthermore, the digital camcorder or camera should preferably be set record in “progressive mode” (in contrast to “interlaced” mode), as objects recorded in interlaced mode tend to have comb-like artifacts during fast movement, and the vertical resolution is also reduced by half in comparison to progressive mode. In addition, the lowest available compression setting (i.e. the highest quality video setting) should preferably be used when recording the image, and the focal length of the camera lens should be fixed while capturing the video (i.e. the zoom function should not be used during recording). In order to capture at least an incremental difference in the viewing angle, the camera should be moved relative to the object between successive images. Alternatively, the object could be rotated together with a lighting source, but this would not be possible when capturing a stationary object, such as a fixed outdoor statue. It should be understood that the preceding are guidelines, and not limitations, and in fact the invention may be used in connection with any suitable image capture device or process.

Furthermore, the camera should be held such that the motion is slow and steady. As the visible motion in the video should be small between successive frames, this may be achieved by shooting a digital video of an object rather than successive still images from a still camera.

Presently, the reconstruction of the 3D surface patch works best for diffuse surface materials. Very shiny, mirrored or transparent surfaces cannot be reconstructed well. The lighting should be at a fixed location relative to the object in order to achieve the best results. Hence, a lamp attached to the camera preferably should not be used. Rather fixed lamps should be used for indoor scenes, or the sun for outdoor scenes. However, if using the sun as light-source, the camera should have a high dynamic range so that parts of the image are not blown out. While a static light source is important, more “balanced” lighting conditions are also very desirable. If a lower quality camera is being used, it may be best to shoot the sequence indoors with just the ceiling lights as light sources. A day with an overcast sky has also been found to be very good. It will be appreciated that these rules of thumb are for guidance only, and are not meant to be limiting in terms of the type of digital image capturing process used.

The Bahkauv statue, as shown in FIGS. 2(a) and 2(b) above, has been reconstructed from a sequence taken with a hand held consumer camera. As noted above, the raw input images for this and the remaining experiments were calibrated by 2d3's Boujou but remained otherwise unmodified. In spite of the specular surface and the changes in lighting conditions, it is an easy task to recover a faithful reconstruction with the present interactive system.

The images of the Monkey sculpture (FIGS. 2(c) and 2(d) above) were taken with a digital SLR camera. Due to the higher resolution (2496×1664), the present method was able to recover much of the fine surface detail. The Chinese Warrior shown in FIGS. 2(e) and 2(f) also demonstrates the high quality that the interactive modeling system of the present invention is able to generate in around three minutes of total interactive reconstruction time for this example. Please note that no foreground segmentation has been applied to any of the input images during experiments conducted by the inventors.

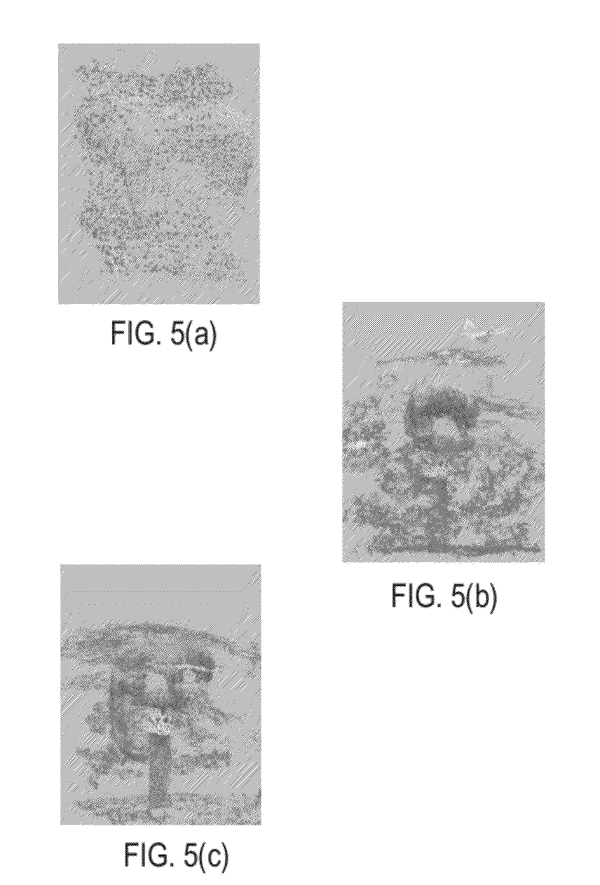

To substantiate the hypothesis that putting the user into the loop significantly reduces the overall reconstruction time and improves the resulting quality, the method and system of the present invention was compared to an existing, fully automatic MVS system. The method of Furukawa and Ponce was chosen since it has been made publicly available and since it is one of the best rated methods in the Middlebury benchmark. The Furukawa and Ponce method was applied three times to the Bahkauv sequence with different parameter settings, starting with the default parameters. The required computation times, the actual parameters used, and the resulting sets of reconstructed surface patches are shown in FIGS. 5(a), 5(b) and 5(c). After more than 36 hours of total computation time, suitable parameters that enable the automatic reconstruction of the Bahkauv statue could not be found. Of course, given the right parameter settings and precise object silhouettes, the system of Furukawa and Ponce will certainly generate a higher quality solution. This experiment illustrates that the search for the right parameter settings in fully automatic reconstruction techniques can be quite time consuming. Furthermore, specifying object silhouettes for complex input images usually requires more precise manual work than the rough sketches needed in accordance with the system and method of the present invention.

The inventors have found that the interactive image-based modeling system works well when using a densely sampled sequence of input images. However, this is not a limitation, as with today's capturing hardware and state-of-the-art structure-from-motion software it is an easy task to quickly generate calibrated sequences with hundreds of images. In contrast to other systems that are often limited in the number of input images due to both memory and computation time constraints, the system in accordance with the present invention is able to handle an arbitrarily large number of input images. Indeed, the number of input images does not influence the overall computation time.

Several previous methods (VideoTrace and Snavely et al. for instance) rely on 3D points from the structure-from motion process to assist the actual interactive reconstruction. The inventors chose not to do so since these points may be very sparse for certain regions of the surface or may not be given at all, as is the case for the Middlebury data. While the mesh-based depth recovery has several advantages, like its robustness against image noise or slight miscalibration, its main limitation is the geometric resolution. Thin structures below the size of the triangle faces cannot be reconstructed. Furthermore, due to the simple photo-consistency measure, the current implementation is only able to handle scenes that do not deviate too much from the Lambertian reflectance model.

Thus, in an aspect of the invention, there is provided a computer-implemented method for processing two-dimensional (2D) images to generate a corresponding three-dimensional (3D) model, comprising: (i) receiving an interactive selection of an image region and displaying the selected image region on an object in a 2D viewer; (ii) generating a surface patch corresponding to the selected image region and displaying the surface patch in a 3D viewer; (iii) reconstructing depth information for the surface patch utilizing an iterative surface reconstruction algorithm; and (iv) displaying the reconstructed surface patch of a 3D model in the 3D viewer.

In an embodiment, the method further comprises changing the angle of view of the object in the 2D viewer, and repeating steps (i) to (iv) to grow the 3D model utilizing overlapping reconstructed surface patches.

In another embodiment, receiving an interactive selection of an image region comprises receiving an input from a stroke-based user interface which paints the selected image region on the object.

In another embodiment, the method further comprises receiving an interactive selection of a modified image region on a previously painted object in the 2D viewer utilizing a paint mode and an erase mode.

In another embodiment, the method further comprises changing the angle of view of the object in the 2D viewer or the model in the 3D viewer by at least one of panning, zooming and rotation, so as to avoid painting over an object silhouette.

In another embodiment, the surface patch corresponding to the selected image region comprises a mesh, and the iterative surface reconstruction algorithm deforms the mesh based on depth maps derived from the selected image region to generate the reconstructed surface patch of the 3D model.

In another embodiment, the mesh is triangular or rectangular, and the iterative surface reconstruction algorithm is executed on a graphics processing unit (GPU) utilizing a multi-view stereo implementation to speed processing, whereby the reconstructed surface patch in the 3D viewer is generated substantially in real-time.

In another aspect, there is provided a system including one or more computer devices having one or more processors and memory for processing two-dimensional (2D) images to generate a corresponding three-dimensional (3D) model, comprising: a user interface for receiving an interactive selection of an image region and displaying the selected image region on an object in a 2D viewer; processing means for generating a surface patch corresponding to the selected image region and displaying the surface patch in a 3D viewer; processing means for reconstructing depth information for the surface patch utilizing an iterative surface reconstruction algorithm; and display means for displaying the reconstructed surface patch of a 3D model in the 3D viewer.

In an embodiment, the system further comprises navigation means for changing the angle of view of the object in the 2D viewer or the model in the 3D viewer.

In another embodiment, the user interface for receiving an interactive selection of an image region includes a stroke-based paint mode for painting the selected image region on the object.

In another embodiment, the user interface for receiving an interactive selection of an image region further includes an erase mode for modifying the selected image region on a previously painted object.

In another embodiment, the system further comprises navigation means for changing the angle of view of the object in the 2D viewer or the model in the 3D viewer by at least one of panning, zooming and rotation.

In another embodiment, the surface patch corresponding to the selected image region comprises a mesh, and the iterative surface reconstruction algorithm deforms the mesh based on depth maps derived from the selected image region to generate the reconstructed surface patch of the 3D model.

In another embodiment, the mesh is triangular or rectangular, and the system further comprises a graphics processing unit (GPU) utilizing a multi-view stereo implementation to execute the iterative surface reconstruction algorithm.

In another aspect, there is provided a computer readable medium storing computer code that when loaded into one or more computer devices adapts the one or more computer devices to process two-dimensional (2D) images to generate a corresponding three-dimensional (3D) model, the computer readable medium comprising: (i) code for receiving an interactive selection of an image region and displaying the selected image region on an object in a 2D viewer; (ii) code for generating a surface patch corresponding to the selected image region and displaying the surface patch in a 3D viewer; (iii) code for reconstructing depth information for the surface patch utilizing an iterative surface reconstruction algorithm; and (iv) code for displaying the reconstructed surface patch of a 3D model in the 3D viewer.

In an embodiment, the computer readable medium further comprises code for changing the angle of view of the object in the 2D viewer, and for re-executing the code in (i) to (iv) to grow the 3D model utilizing overlapping reconstructed surface patches.

In another embodiment, the computer readable medium further comprises code for receiving an interactive selection of an image region utilizing a stroke-based paint mode for painting the selected image region on the object.

In another embodiment, the computer readable medium further comprises code for receiving an interactive selection of an image region utilizing an erase mode for modifying the selected image region on a previously painted object.

In another embodiment, the computer readable medium further comprises code for changing the angle of view of the object in the 2D viewer or the model in the 3D viewer by at least one of panning, zooming and rotation.

In another embodiment, the surface patch corresponding to the selected image region comprises a mesh, and the computer readable medium further comprises code for deforming the mesh utilizing an iterative surface reconstruction algorithm based on depth maps derived from the selected image region to generate the reconstructed surface patch of the 3D model.

In another embodiment, the mesh is triangular or rectangular, and the computer readable medium further comprises code for executing the iterative surface reconstruction algorithm on a graphics processing unit (GPU) utilizing a multi-view stereo implementation.

The present invention may be practiced in various embodiments. A suitably configured computer device, and associated communications networks, devices, software and firmware may provide a platform for enabling one or more embodiments as described above. By way of example, FIG. 6 shows a generic computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse or other navigational device 112, and disk drive or solid state drive 114 connected by an I/O interface 109. In known manner, the mouse 112 or other navigational device may be configured to control movement of a cursor or pointer in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown).

The present invention may be practiced on virtually any manner of computer device including a desktop computer, laptop computer, tablet computer or wireless handheld. As well, it should be understood that the present invention may be implemented to a larger platform, system, or set of tools used in a 3D model creation or modification workflow or content creation or modification that includes 3D model creation or modification, in which case such platform, system, or set of tools provides the system of the present invention.

In the present invention, the full implementation of the invention is operable on a distributed and networked computing environment. This includes implementation of the invention based on Internet-based technology development and service development wherein users are able to access technology-enabled services “in the cloud” without knowledge of, expertise with, or control over the technology infrastructure that supports them (“cloud computing”). Internet-based computing further includes software as a service (“SaaS”), distributed web services, variants described under Web 2.0 and Web 3.0 models, and other Internet-based distribution mechanisms. In order to illustrate the implementation of the present invention in such distributed and networked computing environments, including through cloud computing, the disclosure refers to certain implementations of the invention using “one or more computers”. It should be understood that the present invention is not limited to its implementation on any particular computer system, architecture or network. It should also be understood that the present invention is not limited to a wired network and is implementable using mobile computers and wireless networking architectures, for example by linking wireless devices to the system by a wireless gateway.

The present invention may also be implemented as a computer-readable/useable medium that includes computer program code to enable a computer device to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

What is claimed is:

1. A computer-implemented method for processing two-dimensional (2D) images to generate a corresponding three-dimensional (3D) model, comprising:
(i) receiving an interactive selection of an image region and displaying the selected image region on an object in a 2D viewer;
(ii) generating a surface patch corresponding to the selected image region and displaying the surface patch in a 3D viewer;
(iii) reconstructing depth information for the surface patch utilizing an iterative surface reconstruction algorithm; and
(iv) displaying the reconstructed surface patch of a 3D model in the 3D viewer.

2. The method of claim 1, further comprising changing the angle of view of the object in the 2D viewer, and repeating steps (i) to (iv) to grow the 3D model utilizing overlapping reconstructed surface patches.

3. The method of claim 2, wherein receiving an interactive selection of an image region comprises receiving an input from a stroke-based user interface which paints the selected image region on the object.

4. The method of claim 3, further comprising receiving an interactive selection of a modified image region on a previously painted object in the 2D viewer utilizing a paint mode and an erase mode.

5. The method of claim 3, further comprising changing the angle of view of the object in the 2D viewer or the model in the 3D viewer by at least one of panning, zooming and rotation, so as to avoid painting over an object silhouette.

6. The method of claim 5, wherein the surface patch corresponding to the selected image region comprises a mesh, and the iterative surface reconstruction algorithm deforms the mesh based on depth maps derived from the selected image region to generate the reconstructed surface patch of the 3D model.

7. The method of claim 6, wherein the mesh is triangular or rectangular, and the iterative surface reconstruction algorithm is executed on a graphics processing unit (GPU) utilizing a multi-view stereo implementation to speed processing, whereby the reconstructed surface patch in the 3D viewer is generated substantially in real-time.

8. A system including one or more computer devices having one or more processors and memory for processing two-dimensional (2D) images to generate a corresponding three-dimensional (3D) model, comprising:
a user interface for receiving an interactive selection of an image region and displaying the selected image region on an object in a 2D viewer;
processing means for generating a surface patch corresponding to the selected image region and displaying the surface patch in a 3D viewer;
processing means for reconstructing depth information for the surface patch utilizing an iterative surface reconstruction algorithm; and
display means for displaying the reconstructed surface patch of a 3D model in the 3D viewer.

9. The system of claim 8, further comprising navigation means for changing the angle of view of the object in the 2D viewer or the model in the 3D viewer.

10. The system of claim 9, wherein the user interface for receiving an interactive selection of an image region includes a stroke-based paint mode for painting the selected image region on the object.

11. The system of claim 10, wherein the user interface for receiving an interactive selection of an image region further includes an erase mode for modifying the selected image region on a previously painted object.

12. The system of claim 10, further comprising navigation means for changing the angle of view of the object in the 2D viewer or the model in the 3D viewer by at least one of panning, zooming and rotation.

13. The system of claim 12, wherein the surface patch corresponding to the selected image region comprises a mesh, and the iterative surface reconstruction algorithm deforms the mesh based on depth maps derived from the selected image region to generate the reconstructed surface patch of the 3D model.

14. The system of claim 14, wherein the mesh is triangular or rectangular, and the system further comprises a graphics processing unit (GPU) utilizing a multi-view stereo implementation to execute the iterative surface reconstruction algorithm.

15. A computer readable medium storing computer code that when loaded into one or more computer devices adapts the one or more computer devices to process two-dimensional (2D) images to generate a corresponding three-dimensional (3D) model, the computer readable medium comprising:
(i) code for receiving an interactive selection of an image region and displaying the selected image region on an object in a 2D viewer;
(ii) code for generating a surface patch corresponding to the selected image region and displaying the surface patch in a 3D viewer;
(iii) code for reconstructing depth information for the surface patch utilizing an iterative surface reconstruction algorithm; and
(iv) code for displaying the reconstructed surface patch of a 3D model in the 3D viewer.

16. The computer readable medium of claim 15, further comprising code for changing the angle of view of the object in the 2D viewer, and for re-executing the code in (i) to (iv) to grow the 3D model utilizing overlapping reconstructed surface patches.

17. The computer readable medium of claim 16, further comprising code for receiving an interactive selection of an image region utilizing a stroke-based paint mode for painting the selected image region on the object.

18. The computer readable medium of claim 17, further comprising code for receiving an interactive selection of an image region utilizing an erase mode for modifying the selected image region on a previously painted object.

19. The computer readable medium of claim 17, further comprising code for changing the angle of view of the object in the 2D viewer or the model in the 3D viewer by at least one of panning, zooming and rotation.

20. The computer readable medium of claim 17, wherein the surface patch corresponding to the selected image region comprises a mesh, and the computer readable medium further comprises code for deforming the mesh utilizing an iterative surface reconstruction algorithm based on depth maps derived from the selected image region to generate the reconstructed surface patch of the 3D model.

21. The computer readable medium of claim 20, wherein the mesh is triangular or rectangular, and the computer readable medium further comprises code for executing the iterative surface reconstruction algorithm on a graphics processing unit (GPU) utilizing a multi-view stereo implementation.
